(19) United States
(12) Patent Application Publication
(10) Pub. No.: US 2009/0145832 A1
(43) Pub. Date: Jun. 11, 2009

(54) Pipe separator

(76) Inventors: Per Eivind Gramme, Porsgrunn (NO); Gunnar Hannibal Lie, Porsgrunn (NO)

Correspondence Address: WENDEROTH, LIND & PONACK, L.L.P., 1030 15th Street, N.W.,, Suite 400 East, Washington, DC, 20005-1503, US

(21) Appl. No.: 11/919,760

(22) PCT Filed: Apr. 26, 2006
(86) PCT No.: PCT/NO2006/000155

§ 371 Date: Jan. 25, 2008

(30) Foreign Application Priority Data
May 2, 2005 (NO) 20052141

(51) Int. Cl. B01D 17/02; B01D 45/08

(52) U.S. Cl. 210/247; 55/462

(57) ABSTRACT

A pipe separator for separation of a fluid, in particular separation of fluids with non-mixable fluid components such as oil, gas and water, comprising an extended tubular separator body with a diameter that is principally the same as or slightly larger than the diameter of the inlet pipe and the outlet pipe(s) for the separated components from the separator.

The separator body, from the inlet to the outlet(s), has a curved path or course in one or more parts of its longitudinal design.

The present invention concerns a pipe separator for separation of a fluid, in particular separation of fluids with non-mixable fluid components such as oil, gas and water, comprising an extended tubular separator body with a diameter that is principally the same as or slightly larger than the diameter of the inlet pipe and the outlet pipe from the separator.

Applications for patents for pipe separators of the above type were first submitted by the applicant in the present case in 1996. One of these patent applications is the applicant's own international patent application PCT/NO 03/00265, which shows such a separator. Pipe separators are very effective for separation of fluids with non-mixable fluid components and also represent a simple, structurally light solution compared with conventional gravitation separators. Such prior art separators are designed as extended, principally straight, tubular bodies in which the inlet and outlet pipes connected to the separator are mainly in line with the separator body. However, calculations and tests show that, even if the fluid flow rate is relatively high, the separator body need not necessarily be straight. It can be designed with a curved path without any impact on the separation ability or separation effectiveness of the separator. The advantage of designing the pipe separator with a curved path or course is that the separator can be made much more compact and adapted to the location or the structure in, on or at which it is designed to be arranged. Consequently, the price of this type of separator can also be considerably lower.

The present invention is characterised in that the separator body, from the inlet to the outlet(s), has a curved path or course in one or more parts of its longitudinal design, as specified in the attached independent claim 1. Claims 2-6 indicate the advantageous features of the present invention.

The present invention will be described in further detail in the following using examples and with reference to the attached figures, where:

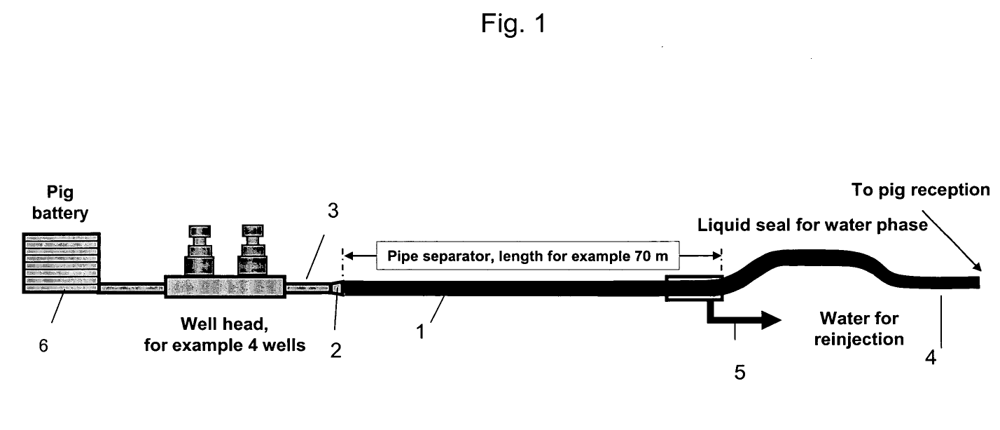

FIG. 1 shows a drawing of a pipe separator in its traditional design,

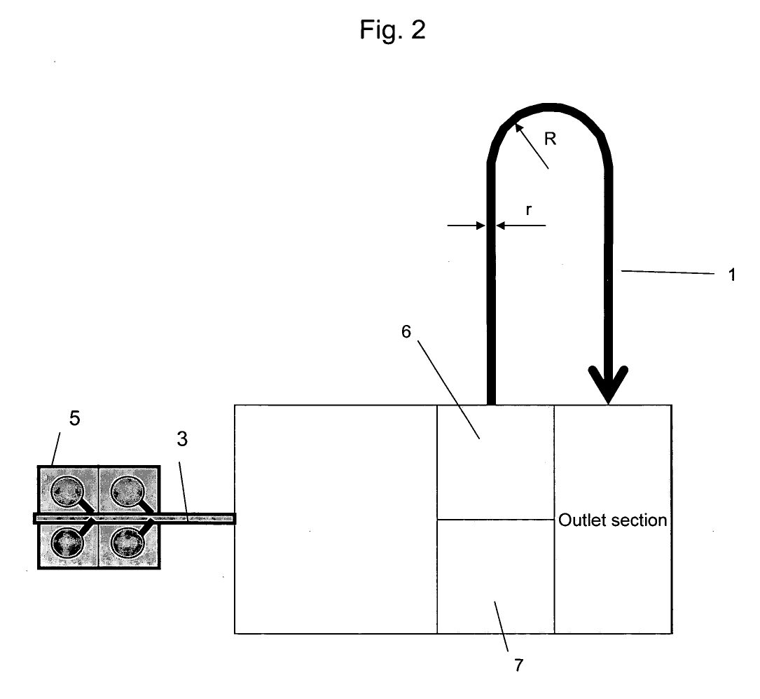

FIG. 2 shows a drawing of a pipe separator in accordance with the present invention with a curved path or course in the form of a U-shaped loop,

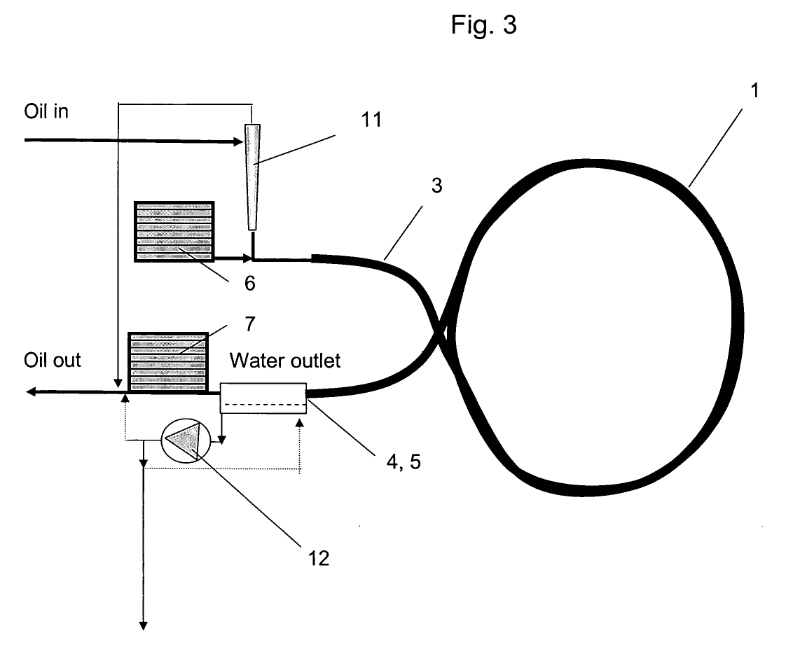

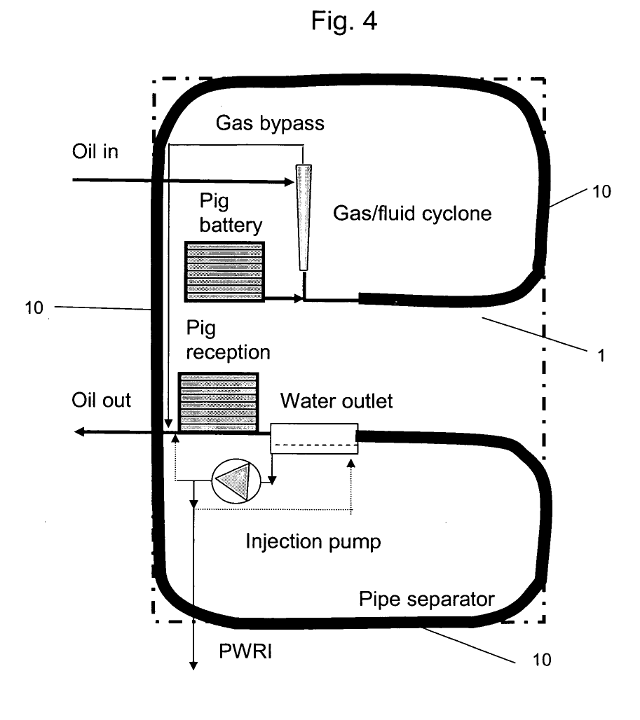

FIGS. 3 and 4 show diagrammatic examples of pipe separators in accordance with the present invention with different curved paths or courses.

As stated above, FIG. 1 shows a drawing of a pipe separator in its traditional design, i.e. in the form of an extended, straight body 1 with an inlet 2 arranged at one end, which is connected to a transport pipe 3 for the supply of the fluid, for example oil/water, to be separated, and outlets 4, 5 for each of the separated fluid components.

FIG. 2 shows a pipe separator in accordance with the present invention, which, in the case shown here, is arranged in connection with a template for a submarine production well 5 for oil and/or gas. Devices 6, 7 (a sender and a receiver for a reamer) are also arranged in connection with the separator for cleaning the separator. The separator body 1 itself is designed with a U-shaped course in the case shown here. Fluid is transported from the well 5 via a transport pipe 3 to the separator 1. Since the separator body is arranged in a U-shaped loop, the separator can easily also be cleaned by reamers or pigs being sent from a pig sender 6 to a pig receiver 7. This solution results in a compact pipe separator, which is also easy to clean.

The radius R of curvature of the separation body 1 in the U-shaped pipe loop can expediently not be smaller than the critical radius for bending a tubular body, i.e. the minimum radius to avoid deformation (compression) of the pipe body during the bending operation (production operation). This may vary somewhat with the material and wall thickness. However, for steel, as a rule of thumb, it should not exceed three times the radius of the pipe body, i.e. R>3r. Expediently, the radius R should be somewhat larger, for example R>5r.

FIG. 3 shows another example of a pipe separator in accordance with the present invention. The solution is essentially the same as in FIG. 2, but the separator body is in a spiral loop to increase the length and thus the effectiveness of the separator body. In the case shown here, in which the height of the pipe body in the loop varies, the inlet should expediently be above the outlet and the fall to the pipe body, from the inlet to the outlet, should not exceed −0.5 degrees (minus half a degree) for a three-phase separator and −3 degrees (minus three degrees) for an oil/water separator to avoid the flow rate of the fluid in the separator exceeding an expected rate that creates turbulence and thus non-laminar flow. The solution in the case shown here shows, in addition to the components shown in the previous examples, a pump 12 for the return or further transportation of water and a hydrocyclone 11.

FIG. 4 shows a third example of a separator in accordance with the present invention in which the separator body is adapted to the frame of a submarine template. In this case, the pipe body 1 is laid along the frame structure's 10 sides so that the space on the template is used effectively. Alternatively, the pipe body 1 can, in itself, where expedient, constitute an integrated part of the frame structure and thus constitute a supporting part of it.

Please note that the invention, as it is defined in the claims, is not limited to the embodiments shown and described above, which are based on a template in which the separator is arranged. Therefore, the pipe separator with the design specified can be used in any context in which there is a need to separate fluid, for example on a platform, on a ship or in any process plant on land, in a building or in the open.

1-6. (canceled)

7. A pipe separator for separation of a fluid, in particular separation of fluids with non-mixable fluid components such as oil, gas and water, comprising an extended tubular separator body with a diameter that is principally the same as or slightly larger than the diameter of the inlet pipe and the outlet pipe(s) for the separated components from the separator, wherein the separator body, from the inlet to the outlet(s), has a curved path or course in one or more parts of its longitudinal design.

8. A pipe separator in accordance with claim 7, wherein the separator body has a U-shaped course.

9. A pipe separator in accordance with claim 7, wherein the separator body has a circular, semicircular or spiral course.

10. A pipe separator in accordance with claim 7, wherein the radius (R) of curvature of the separator body is not less than three times the separator body's radius (r).

11. A pipe separator in accordance with claim 7, wherein the radius (R) of curvature of the separator body is not less than five times the separator body's radius (r).

12. A pipe separator in accordance with claim 7, the separator body has a rise or fall from the inlet to the outlet that does not exceed an angle of 0.5, respectively 3 degrees.
